(19) United States
(12) Patent Application Publication
(10) Pub. No.: US 2012/0321134 A1
(43) Pub. Date: Dec. 20, 2012

(54) FACE TRACKING METHOD AND DEVICE

(75) Inventors: Xiaolu SHEN, Beijing (CN); Xuetao Feng, Beijing (CN); Jung Bae Kim, Beijing (CN); Hui Zhang, Beijing (CN)

(73) Assignee: Samsung Electornics Co., Ltd, Suwon-si (KR)

(21) Appl. No.: 13/523,221

(22) Filed: Jun. 14, 2012

(30) Foreign Application Priority Data
Jun. 15, 2011 (CN) 20110166523.X
Apr. 9, 2012 (KR) 10-2012-0036728

(51) Int. Cl. G06K 9/46; G06K 9/00

(52) U.S. Cl. 382/103; 382/154

(57) ABSTRACT

Device and method for tracking human face are provided. The device may include an image collection unit to receive a video image and output a current frame image included in the received video image to a prediction unit, the prediction unit to predict a 2-dimensional (2D) position of a key point of a human face in a current frame image output through the image collection unit based on 2D characteristics and 3-dimensional (3D) characteristics of a human face in a previous image obtained through a face fitting unit, and to output the predicted 2D position of the key point to the face fitting unit, and the face fitting unit to obtain the 2D characteristics and the 3D characteristics by fitting a predetermined 2D model and 3D model of the human face based on the 2D position of the key point predicted by the prediction unit using at least one condition.

### CROSS-REFERENCE TO RELATED APPLICATIONS

This application claims the priority benefit of Korean Patent Application No. 10-2012-0036728 filed on Apr. 9, 2012, in the Korean Intellectual Property Office, and Chinese Patent Application No. 20110166523.X, filed on Jun. 15, 2011, in the State Intellectual Property Office of the Peoples' Republic of China, the disclosures of which are incorporated herein by reference.

### BACKGROUND

1. Field

Embodiments relate to a technology for tracking an object in a video image, and more particularly, to a device and method for continuously tracking 2-dimensional (2D) characteristics and 3-dimensional (3D) characteristics of a human face in a video image.

2. Description of the Related Art

With development in an information processing technology, particularly a video image technology, various systems and devices are recently required to perform tracking and identification of a specific object, for example a human face, in a video image. For instance, to identify and analyze an actual situation on the spot, a human face needs to be tracked in sequential video images of a plurality of video camera monitoring systems. In addition, as 2-dimensional (2D) information and 3D information of a tracked human face reflect an expression or a shape of the human face, emotion of a user may be recognized in relation to characteristic of the human face being sequentially tracked in a human computer interaction (HCI) system. When the emotion corresponds to an operation instruction being input, smarter and friendlier interaction may be achieved. Accordingly, the characteristic of the tracked human face may be applied for production of animation of a face area, focus measurement, automated monitoring, and the like.

To implement face tracking, according to related arts, spatial information for easy recognition of a tracked human face is added using additional methods such as a structured light projector, a redirect stroboscopic light source, and a paste mark. Next, tracking analysis is performed by capturing the spatial information in a video image. For example, in Chinese Patent Application No. 200610085748 entitled ‘Face setting method based on structured light,’automated projection of structured light is performed with respect to a human face, and a central position of the human face is set by extracting structured light stripes by an image capturing device included in a video system. The foregoing method takes a long preparation time in an initial step and needs cooperation of a user. Therefore, application fields of the foregoing method are limited. For example, the foregoing method is not applied to general home appliances nor used for tracking of a human face displayed on a monitoring system.

Another method generally used in related arts performs tracking based on image characteristics such as color, grayscale, histogram, edge shape, and the like, and fixes a position of a face or positions of face organs in an image using a specific search strategy. For example, in Chinese Patent Application No. 200910080962 entitled ‘Method, device, and video processing chip for identifying face organs,’ initial positions of the face organs shown on an identified image are fixed using a grayscale statistical model, and a lower jaw edge point is set and adjusted using face edge information searching, thereby converting a color space of an identified image from an RGB mode to a color saturation mode. Also, a lip edge point is set and adjusted using chromatic value searching, thereby setting positions of the face organs based on edge points of the face organs shown on the identified image. However, the foregoing method shows low adaptability to changes of light and shape, and is complicated. Therefore, the foregoing method is not applicable to tracking of the entire part.

Additionally, a method for positioning a face image based on a face model is disclosed in related arts. For example, Chinese Patent Application No. 200910143325 entitled ‘Method for positioning two-dimensional face images structures a 2-dimensional (2D) face shape model and a 2D face area texture model using a predetermined database and accurately positions 2D face images. However, the foregoing method is limited in obtaining information about 3D position or shape and insufficient for processing of samples except the database. Therefore, the foregoing method is not applied when changes in an expression or shape are great.

As aforementioned, according to the related arts, additional devices such as a structural light projector or a paste mark attached to a human face are necessary to implement face tracking in a video image. Therefore, price of the tracking device is increased and a tracking system is complicated. Furthermore, a use environment of the face tracking is limited.

In addition, a great deal of calculation needs to be performed for accurate face tracking. Complicated calculation does not even satisfy real time tracking.

Also, most of the related-art tracking methods obtain only 2D characteristics of a human face, while not obtaining corresponding 3D characteristics simultaneously and efficiently. Thus, application of a tracking result is limited. That is, the 2D characteristics and the 3D characteristics are not obtained simultaneously and efficiently.

Moreover, in a case that a tracked human face is unacquainted, for example when an input face is much different from a face stored in a training base, the related-art tracking methods may not obtain a satisfactory result under the conditions of a great change in angle, a strong or asymmetrical expression, non-uniform light, a complex background, or a quick motion.

### SUMMARY

According to an aspect of one or more embodiments, there may be provided a face tracking device and method, which obtain 2-dimensional (2D) characteristics and 3-dimensional (3D) characteristics of a human face by predicting a face area shown in a video image and fitting a predetermined 2D model and 3D model of the human face using at least one condition based on a prediction result.

According to an aspect of one or more embodiments, there is provided a device for tracking a human face in a video image, the device including an image collection unit to receive a video image and output a current frame image included in the received video image to a prediction unit, the prediction unit to predict a 2-dimensional (2D) position of a key point of a human face in a current frame image output through the image collection unit based on 2D characteristics and 3-dimensional (3D) characteristics of a human face in a previous image obtained through a face fitting unit, and to output the predicted 2D position of the key point to the face fitting unit, and the face fitting unit to obtain the 2D characteristics and the 3D characteristics by fitting a predetermined 2D model and 3D model of the human face based on the 2D position of the key point predicted by the prediction unit using at least one condition.

The 2D characteristics may include a 2D shape, and the 3D characteristics may include a 3D structure.

The face fitting unit may set the key point predicted by the prediction unit to an initial value, and fit a predetermined 2D model and 3D model of the human face using the at least one condition.

The prediction unit may extract a feature point of a face area from the current frame image output from the image collection unit, and match the extracted feature point to a feature point of a previous frame image, thereby calculating a 3D shape of a human face in the previous frame image based on a 2D position and a 3D structure of the human face in the previous frame image obtained through the face fitting unit, calculate a position of the feature point in the 3D structure, based on a 2D position of a feature point in the extracted previous frame image, a 3D structure of a key point of the human face in the previous frame image obtained through the face fitting unit, and the 3D shape of the human face in the previous frame image, calculate a 3D shape of the human face in the current frame image based on the position of the feature point in a 2D position and a 3D structure of the matched feature point of the human face in the current frame image, calculate the 2D position of the key point of the human face in the current frame image, based on the 3D structure of the key point of the human face in the previous frame image obtained through the face fitting unit and the calculated 3D shape of the human face in the current frame image, and output the 2D position of the key point to the face fitting unit.

The prediction unit may determine the feature point of the face area extracted from a first frame image to be a 2D position of the key point directly predicted.

The prediction unit set a threshold value determining a feature point to a self adaptation threshold value according to an actual state change when the feature point of the face area is extracted from the current frame image output from the image collection unit.

The prediction unit may remove an abnormal matching result by using a random sample consensus (RANSAC) method and setting a distance threshold value, when the extracted feature point is matched to the feature point of the frame image

The face fitting unit may fit the predetermined 2D model and 3D model of the human face based on the 2D position of the key point predicted by the prediction unit using a plurality of conditions including a 2D appearance condition and a 3D structure condition.

The face fitting unit may fit the predetermined 2D model and 3D model of the human face according to at least one condition selected from a 2D deformation condition, a feature point condition, a skin color feature point, a personality texture condition.

The 2D shape may be expressed by an equation below:

S(p,q)=T(S(p),q),

wherein S(p) denotes a flexible shape and is expressed by

$$S ( p ) = {S}_{0} + {\sum }_{i} {p}_{i} {S}_{i} , {S}_{0}$$

denotes an average shape in a 2D model, Sᵢ denotes a series of shape primitives S₁, S₂, S₃, in the 2D model, each of which denotes a change type of the 2D shape, p=[p₁, p₂, p₃, . . . ] denotes a 2D flexible shape parameter indicating a change intensity of each shape primitive, q=[q₁, q₂, q₃, q₄] denotes a 2D stiffness shape parameter, in which q₁ and q₂ denote displacement of a 2D face shape on a plane and q₃ and q₄ denote rotation, contraction, and expansion of the 2D face shape on the plane, and T denotes a stiffness deformation of the 2D shape based on the displacement, rotation, contraction, and expansion.

The 3D structure may be expressed by an equation below:

S̅( p̅, q̅)= T̅( S̅( p̅), q̅)

wherein S̅( p̅) denotes a 3D flexible shape and is expressed by

$$\overline{S} ( \overline{p} ) = {\overline{S}}_{0} + {\sum }_{i} {\overline{p}}_{i} {\overline{S}}_{i} ,$$

S̅₀ denotes an average structure in a 3D model, S̅ᵢ a series of structure primitives S̅₁, S̅₂, S̅₃, . . . in the 3D model, each of which denotes a change type of the 3D structure, p̅= p̅₁, p̅₂, p̅₃, . . . denotes a 3D flexible structure parameter indicating a change intensity of each structure primitive, q̅=[θₓ, θ_{y}, θ_{z}, Oₓ, O_{y}, O_{z}] denotes a set of 3D stiffness structure parameters, in which Oₓ, O_{y}, and O_{z} denote angles by which a 3D face structure is rotated along X, Y, and Z axes in a space and θₓ, θ_{y}, and θ_{z} denote displacement of the 3D face structure in the space, and T denotes a stiffness deformation of the 3D structure based on the rotation and displacement.

The face fitting unit may set the 2D deformation condition to ∥p∥², and as a deformation degree ∥p∥² corresponding to the 2D flexible shape parameter p is smaller, a 2D structure obtained through face model fitting may become more ideal.

The face fitting unit may set the feature point condition to ∥U(S(p)−V)∥², wherein U(S(p)) denotes a position of a feature point obtained when a feature point matched in the current frame image is deformed to the average shape S₀, V denotes a position of the feature point matched to the previous frame image, the feature point after deformation. As a difference U(S(p)−V)∥² between feature points matched to neighboring two frame images is smaller, the 2D structure obtained through face model fitting may become more ideal.

The face fitting unit may set the skin color condition to ∥C(S(p,q))∥², wherein C(x) denotes similarity between a point in a position x and a skin color in the current frame image. As a difference ∥C(S(p,q))∥² between each key point in the 2D shape S(p,q) and the skin color is smaller, the 2D structure obtained through face model fitting may become more ideal.

The face fitting unit may set a function C(x) using a key frame in the video image, and the key frame may denote one representative frame image of the video image.

The face fitting unit may initially set a first frame image to the key frame, and update the previously used key frame using a more representative frame image when the more representative frame image is measured.

The face fitting unit may set the personality texture condition to ∥I(S(p,q))−W∥² wherein W denotes a personality texture of a tracked human face, I(S(p,q)) denotes a 2D personality texture obtained when the current frame image is deformed to the average shape S₀. As a difference ∥I(S(p,q))−W∥² between the personality texture I(S(p,q)) obtained through deformation and the personality texture W of the tracked human face is smaller, a 2D shape obtained through face model fitting may become more ideal.

The deformation may be performed using separate Affine deformation.

The face fitting unit may determine the personality texture W using a key frame in the video image, and the key frame may denote one representative frame image of the video image.

The face fitting unit may initially set a first frame image to the key frame, and update the previously used key frame using a more representative frame image when the more representative frame image is measured.

The at least one condition may form a cost function according to an equation below:

$$E ( p , q , \overline{p} , \overline{q} ) = {‖ I ( S ( p , q ) ) - A ‖}^{2} + {k}_{3 D} {‖ P ( \overline{S} ( \overline{p} , \overline{q} ) ) - S ( p , q ) ‖}^{2} + \frac{{k}_{d}}{N} {‖ p ‖}^{2} + \frac{{k}_{f}}{m} {‖ U ( S ( p ) - V ) ‖}^{2} + {k}_{s} {‖ C ( S ( p , q ) ) ‖}^{2} + {k}_{t} {‖ I ( S ( p , q ) ) - W ‖}^{2}$$

wherein N denotes a number of the 2D flexible shape parameters, m denotes a number of the matched feature points, k_{3D} denotes a weight of the 3D structure condition, k_{d} denotes a weight of the 2D deformation condition, k_{f} denotes a weight of the feature point condition, kₛ denotes a weight of the skin color condition, kₜ denotes a weight of the personality texture condition, and wherein the face fitting unit may set the key point predicted by the prediction unit as an initial value, thereby obtaining parameters p, q, p̅, and q̅ corresponding to a case in which the cost function has a minimum value and setting the 2D shape and the 3D structure of the tracked human face.

The face fitting unit may set a weight of each of the at least one condition according to practical necessity and characteristics of the tracked video image.

According to an aspect of one or more embodiments, there is provided a method for tracking a human face in a video image, the method including receiving a video image and outputting a current frame image which is the received video image, by an image collection unit, predicting a 2D position of a key point of a human face in the current frame image output through the image collection unit based on 2D characteristics and 3D characteristics of a human face in a previous image obtained by a face fitting unit and outputting the predicted 2D position of the key point to the face fitting unit, by the prediction unit, and obtaining the 2D characteristics and the 3D characteristics of the human face by fitting a predetermined 2D model and 3D model of the human face by the face fitting unit based on the 2D position of the key point predicted by the prediction unit using at least one condition.

The predicting of the 2D position of the key point of the human face in the current frame image output by the image collection unit by the prediction unit, may include extracting a feature point of a face area from the current frame image output from the image collection unit, and matching the extracted feature point to a feature point of a previous frame image, thereby calculating a 3D shape of a human face in the previous frame image based on a 2D position and a 3D structure of the human face in the previous frame image obtained through the face fitting unit, calculating a position of the feature point in the 3D structure, based on a 2D position of a feature point in the extracted previous frame image, a 3D structure of a key point of the human face in the previous frame image obtained through the face fitting unit, and the 3D shape of the human face in the previous frame image, calculating a 3D shape of the human face in the current frame image based on the position of the feature point in a 2D position and a 3D structure of the matched feature point of the human face in the current frame image, and calculating the 2D position of the key point of the human face in the current frame image, based on the 3D structure of the key point of the human face in the previous frame image obtained through the face fitting unit and the calculated 3D shape of the human face in the current frame image.

According to another aspect of one or more embodiments, there is provided at least one non-transitory computer readable medium storing computer readable instructions to implement methods of one or more embodiments.

### BRIEF DESCRIPTION OF THE DRAWINGS

These and/or other aspects will become apparent and more readily appreciated from the following description of embodiments, taken in conjunction with the accompanying drawings of which:

FIG. 1 is a block diagram of a face tracking device according to embodiments;

FIG. 2 is a flowchart illustrating a face tracking method according to embodiments;

FIG. 3 is a flowchart illustrating a method of predicting a motion using a prediction unit, according to embodiments of FIG. 1;

FIG. 4 is a diagram illustrating a motion prediction method according to embodiments of FIG. 1

FIG. 5 is a diagram illustrating an example of 2-dimensional (2D) appearance deformation according to embodiments; and

FIGS. 6A to 6C are diagrams illustrating an improvement in performance of a face tracking scheme according to embodiments in comparison to a related art.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

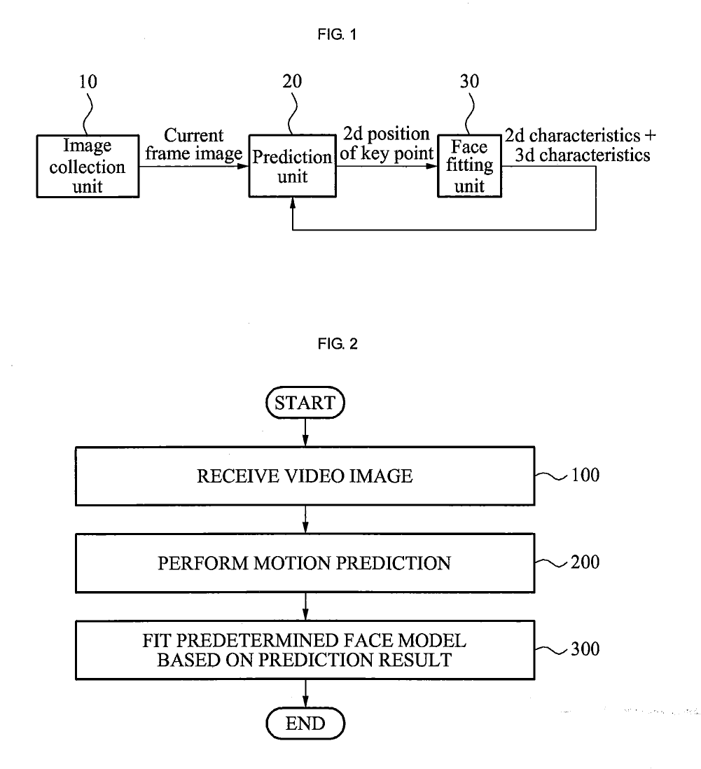

FIG. 1 illustrates a face tracking device according to embodiments. As shown in FIG. 1, the face tracking device may include an image collection unit (image collector) 10 adapted to receive a video image and output a current frame image included in the received video image to a prediction unit (predictor) 20. The prediction unit 20 may be adapted to predict a 2-dimensional (2D) position of a key point of a human face in a current frame image output through the image collection unit 10 based on 2D characteristics and 3-dimensional (3D) characteristics of a human face in a previous image obtained through a face fitting unit (face fitter) 30. The prediction unit 20 may output the predicted 2D position of the key point to the face fitting unit 30, and the face fitting unit 30 may be adapted to obtain the 2D characteristics and the 3D characteristics by fitting a predetermined 2D model and 3D model of the human face based on the 2D position of the key point predicted by the prediction unit 20 using at least one condition.

In the face tracking device according to embodiments, the 2D position of the key point of the human face in the current frame image is predicted by the prediction unit 20 using basic conditions so as to perform face fitting. Therefore, speed of a tracking algorithm may be increased and real-time conditions may be satisfied. Also, the prediction may be performed simply by inputting, to the prediction unit 20, a current frame image included in a video image and characteristics of a human face included in a previous frame image which is already fit. That is, the face tracking device may need only a single video image source but not an additional video camera or additional image information obtaining unit.

To obtain more accurate characteristics of the human face, the face fitting unit 30 may fit the 2D model and the 3D model based on the predicted 2D position of the key point, using the at least one condition.

The face tracking device according to embodiments fits the predetermined 2D model and 3D model based on a result of prediction of a motion in the video image, using the at least one condition. Therefore, the face tracking device may obtain the 2D characteristics and the 3D characteristics of the human face, simultaneously, and predict a video image of a next frame based on the 2D characteristics and the 3D characteristics. Accordingly, embodiments are not limited to a specific prediction method or fitting method. Besides the motion prediction method and the fitting method introduced in embodiments, other methods for motion prediction and fitting already disclosed in the art may be applied as long as appropriate for corresponding prediction and fitting, so as to overcome limits of face tracking.

Hereinafter, a face tracking method according to embodiments using the face tracking device shown in FIG. 1 will be described with reference to FIG. 2.

FIG. 2 illustrates the face tracking method according to embodiments. Referring to FIG. 2, in operation 100, the video image is received by the image collection unit 10 and the received video image, that is, a current image, is output to the prediction unit 20. For example, the video image may be a video image obtained by a general video camera. In operation 200, the prediction unit 20 may predict the 2D position of the key point of the human face in the current frame image output in operation 100 by the image collection unit 10, based on the 2D characteristics and the 3D characteristics of the human face in the previous frame image obtained by the face fitting unit 30 (perform motion prediction). In operation 300, the face fitting unit 30 may fit the predetermined 2D model and 3D model based on the 2D position of the key point predicted in operation 200 by the prediction unit 20, using the at least one condition, thereby obtaining the 2D characteristics and the 3D characteristics of the human face (fit predetermined face model based on prediction result).

As aforementioned, the face tracking method according to embodiments fits the predetermined 2D model and 3D model based on the result of prediction of the motion in the video image, using the at least one condition, thereby obtaining both the 2D characteristics and the 3D characteristics of the human face. Also, the face tracking method may predict a video image of a next frame based on the 2D characteristics and the 3D characteristics. Accordingly, the method according to embodiments is not limited to a specific prediction method or fitting method. Besides the motion prediction method and the fitting method introduced in embodiments, other methods for motion prediction and fitting already disclosed in the art may be applied as long as appropriate for corresponding prediction and fitting, so as to overcome limits of face tracking.

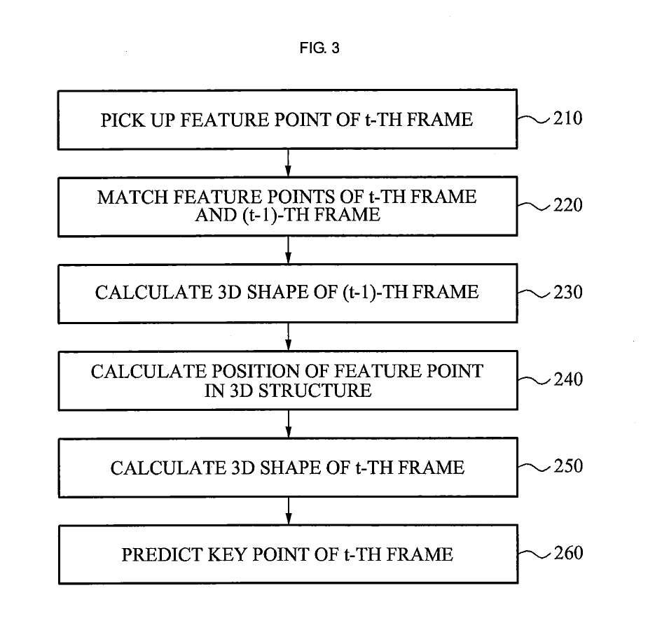

Hereinafter, a process of performing the motion prediction by the prediction unit 20 in operation 200 will be described. FIG. 3 illustrates a method of performing the motion prediction using the prediction unit 20. Referring to FIG. 3, in operation 210, the prediction unit 20 may extract a feature point of a face area from a current frame image, for example a t-th frame image, output from the image collection unit 10. Here, for example, the prediction unit 20 may extract the feature point of the face area, using multi scale speeded up robust features (SURF) and a FAST operator. The feature point may refer to a point having a particular position or a particular appearance in the image. During the extraction of the feature point, a threshold value determining the feature point may be set to a self adapting threshold value according to changes in an actual state. For example when the video image is unclear due to a low contrast and a motion, the self adapting threshold value may be adjusted so that the corresponding feature point may be extracted even in such a state. However, the method of extracting the feature point of the face area is not limited to the multi scale SURF and the FAST operator. Also, the self adapting threshold value is not indispensable. The FAST operator, which was recently developed, was designed as a high speed feature detector for application in real-time frame-rate digital photogrammetry and computer vision. It employs a high-speed algorithm that is computationally simple and effective for real-time applications. The FAST operator has been found to generally outperform other operators in speed. Beyond its speed, a second advantage of the FAST operator is its invariance to rotation and changes in scale.

Next, in operation 220, the prediction unit 20 may match a feature point of the current frame image extracted in operation 210, that is, the t-th frame image, to a feature point of a previously extracted frame image, that is, a (t−1)-th frame image. For example, when extracting the feature point, the prediction unit 20 may match the same type of feature points included in two frame images according to types of obtained feature points. For example, the prediction unit 20 may use a RAndom SAmple Concensus (RANSAC) method. The predict unit 20 may securely obtain fully matched feature points by removing abnormally matched feature points, by setting a distance threshold value. However, the method of matching the feature points of the face area in two neighboring frame images is not limited to embodiments. Any other methods for extracting and matching features disclosed in the corresponding field may be used.

Next, in operation 230, the prediction unit 20 may calculate a 3D shape of the human face included in the (t−1)-th frame image, based on the 2D position and the 3D structure of the key point of the human face included in the (t−1)-th frame image obtained by the face fitting unit 30. For example, the prediction unit 20 may perform the foregoing operation using a Pose from Orthography and Scaling with ITeration (POSIT) algorithm. However, embodiments are not limited to the POSIT algorithm, and any other methods for calculating the 3D shape of the human face included in the (t−1)-th frame image from the 2D position and the 3D structure of the key point of the human face included in the (t−1)-th frame image may be used.

Next, in operation 240, the prediction unit 20 may calculate the position of the feature point included in the 3D structure, based on the 2D position of the matched feature point of the human face included in the extracted (t−1)-th frame image, the 3D structure of the key point of the human face included in the (t−1)-th frame image obtained by the face fitting unit 30, and the 3D shape of the human face included in the (t−1)-th frame image calculated in operation 230.

In general, since the feature point in the 3D structure is displaced by a minor degree between the two neighboring frame images, the feature point obtained in operation 240 may be used as 3D information of the feature point of the human face in the t-th frame image. Correspondingly, in operation 250, a 3D shape of the human face included in the t-th frame image may be calculated, based on the 2D position of the feature point matched to the human face included in the t-th frame image extracted by the prediction unit 20 in operation 210 and a position of the key point in the 3D structure, the key point of the human face included in the t-th frame image obtained in operation 240. For example, the prediction unit 20 may perform the foregoing operation using the POSIT algorithm.

Next, in operation 260, the prediction unit 20 may calculate the 2D position of the key point of the human face included in the t-th frame image, based on the 3D structure of the key point of the human face included in the (t−1)-th frame image obtained by the prediction unit 20 using the face fitting unit 30 and the 3D shape of the human face included in the t-th frame image calculated in operation 250, and may output the 2D position of the key point to the face fitting unit 30. Here, the key point may refer to a point of a particular position on the human face, such as a mouth edge, a middle of lips, eye corners, eyebrow ends, and the like. The position of the key point may refer to a representative structure. The key point may correspond to the key point included in the predetermined 2D model and 3D model. Hereinafter, the foregoing will be described in greater detail.

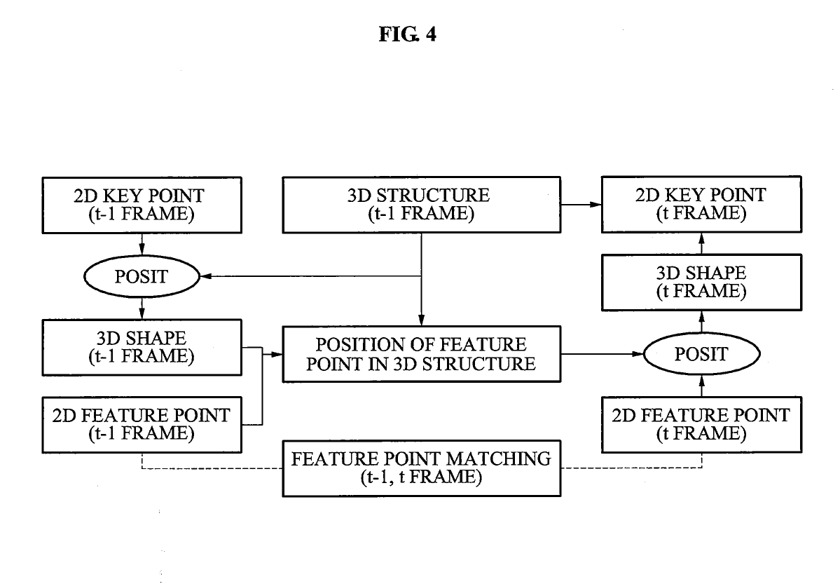

In the above, the method for performing motion prediction using the prediction unit 20 has been described referring to FIG. 3. Although operations 210 through 260 are sequentially described above, the process of performing motion prediction are not limited to the disclosure shown in FIG. 3. That is, as shown in FIG. 4 which illustrates a motion prediction method according to embodiments of FIG. 1, the motion prediction method according to embodiments may be used when the motion prediction process is completed according to FIG. 4. In addition, the POSIT algorithm shown in FIG. 4 is only an example and is not limiting.

In addition, the operation of the prediction unit 20 predicting the 2D position of the key point of the human face included in the t-th frame image after reception of the t-th frame image based on the 2D characteristics and the 3D characteristics of the human face included in the (t−1)-th frame image has been described. However, a first frame image does not use a previous frame image for motion prediction. Therefore, when the first frame image performs motion prediction according to embodiments, the 2D feature point of the human face extracted from the first frame image by the prediction unit 20 in operation 210 may be set to a 2D position of a directly predicted key point and provided to the face fitting unit 30.

The motion prediction by the prediction unit 20 has been described as aforementioned. Hereinafter, an operation of the face fitting unit 30 fitting the predetermined 2D model and 3D model based on the 2D position of the key point predicted by the prediction unit 20 using at least one condition, and obtaining the 2D characteristics and the 3D characteristics of the human face will be described.

According to embodiments, the face fitting unit 30 may fit the predetermined 2D model and 3D model using the 2D position of the key point obtained through motion prediction by the prediction unit 20. That is, respective key points in the 2D model and the 3D model are matched to the key point in the video image. Accordingly, actual 2D characteristics and 3D characteristics of the human face may be obtained.

For example, a face model may be structured according to embodiments described below.

Prior to the description, terms related to the face model will be defined.
2D shape S: A position of a 2D key point included in a human face and predetermined in number. Examples include a mouth edge, a middle of lips, eye corners, and eyebrow ends.
2D appearance A: Appearance information corresponding to a face area. Examples include a grayscale value, a gradient, and the like of an image of the face area.
3D structure S̅: A position of 3D key point included in the human face and predetermined in number. Examples include a mouth edge, a middle of lips, eye corners, and eyebrow ends.

With reference to the above description, a 2D shape model, a 2D appearance model, and a 3D structure model may be obtained in the following manner.
2D shape model: An average shape S₀ and a series of shape primitives S₁, S₂, S₃, . . . constitute the 2D shape model. Here, each shape primitive Sᵢ refer to a change type of the 2D shape. For example, opening of a mouth or frowning in the human face may be included.
2D appearance model: An average appearance A₀ and a series of appearance primitives A₁, A₂, A₃, . . . constitute the 2D appearance model. Here, each appearance primitive Aᵢ may refer to a change type of the 2D appearance. For example, a left side of the human face may be darkened while a right side is brightened.
3D structure model: An average appearance S̅₀ and a series of structure primitives S̅₁, S̅₂, S̅₃, . . . may constitute the 3D structure model. In the same manner as the 2D shape model, each structure primitive S̅ᵢ may refer to a change type of the 3D structure. For example, opening of a mouth or frowning in the human face may be included.

For example, the 2D shape and the 3D structure of the human face may be calculated using an automatic appearance model disclosed in the related art.

A 2D flexible shape parameter may be set to p=[p₁, p₂, p₃, . . . ] which refers to a change intensity of each shape primitive. The 2D flexible shape may be expressed by

$$S ( p ) = {S}_{0} + {\sum }_{i} {p}_{i} {S}_{i} .$$

A 2D stiffness shape parameter may be set to q=[q₁, q₂, q₃, q₄] in which q₁ and q₂ denote displacement of a 2D face shape on a plane and q₃ and q₄ denote rotation, contraction, and expansion of the 2D face shape on the plane. A stiffness deformation T with respect to the 2D shape may collectively refer to the displacement, rotation, contraction, and expansion. The stiffness deformation T may be performed after the flexible deformation, accordingly obtaining the 2D shape S(p,q)=T(S(p),q).

A 2D flexible shape parameter may be set to p̅=[ p̅₁, p̅₂, p̅₃, . . . ] which refers to a change intensity of each structure primitive. A 3D flexible structure may be expressed by

$$\overline{S} ( \overline{p} ) = {\overline{S}}_{0} + {\sum }_{i} {\overline{p}}_{i} {\overline{S}}_{i} .$$

A 3D stiffness structure parameter may be set to q=[θₓ, θ_{y}, θ_{z}, Oₓ, O_{y}, O_{z}] in which q̅=[θₓ, θ_{y}, θ_{z}, Oₓ, O_{y}, O_{z}] denotes a set of 3D stiffness structure parameters, in which Oₓ, O_{y}, and O_{z} denote angles by which a 3D face structure is rotated along X, Y, and Z axes in a space and θₓ, θ_{y}, and θ_{z} denote displacement of the 3D face structure in the space. A stiffness deformation T̅ with respect to the 3D structure may collectively refer to the displacement and rotation. The stiffness deformation T̅ may be performed after the flexible deformation, accordingly obtaining the 3D structure S̅( p̅, q̅)= T̅( S̅( p̅), q̅).

Here, the 2D appearance may be obtained using a corresponding algorithm in the automatic appearance model. However, the algorithm, which departs from the scope of embodiments, will not be described in detail.

As aforementioned, a 2D shape and a 3D structure may be obtained using values of the parameters p, q, p̅, and q̅ based on the predetermined 2D model and 3D model of the human face. Here, the parameters p and q may be used to determine the 2D shape while the parameters p̅ and q̅ may be used to determine the 3D structure.

Therefore, for example, the face fitting unit 30 may obtain the 2D characteristics and the 3D characteristics of the human face, by fitting the predetermined 2D model and 3D model of the human face based on the 2D position of the key point predicted by the prediction unit 20, using at least one condition.

According to embodiments, the face fitting unit 30 may be used to set the key point predicted by the prediction unit 20 to an initial value, and accordingly obtain a fitting result of which a matching cost is minimum using the at least one condition. The at least one condition may be used to properly revise the prediction result, being not specifically limited as described below. That is, any condition capable of properly revising any prediction result may be applied to solve the technical limit. In addition, more effective conditions may increase technical effects.

For example, the face fitting unit 30 may fit the 2D model and the 3D model of the human face by the 2D appearance condition and the 3D structure condition.

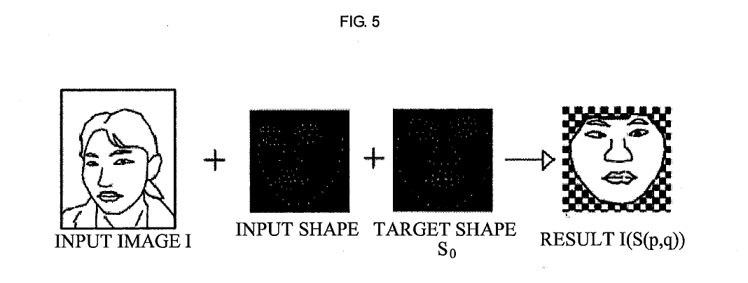

The 2D appearance condition may be set to ∥I(S(p,q))−A∥² in which A denotes a 2D appearance, S(p,q) denotes a 2D shape, and I(S(p,q)) denotes a 2D texture obtained when an input image I is deformed to a target shape, that is, the average shape S₀. For example, piece-wise warping may be used for the deformation. FIG. 5 illustrates an example of 2D appearance deformation according to embodiments of FIG. 1. Referring to FIG. 5, the face fitting unit 30 may receive the video image I collected by the image collection unit 10. Based on the 2D position of the key point predicted by the prediction unit 20 and the average shape S₀ in the predetermined 2D model, the 2D texture I(S(p,q)) corresponding to the 2D shape S(p,q) may be obtained through deformation by the piece-wise warping. For example, according to the automatic appearance model algorithm, as a difference ∥I(S(p,q))−A∥² between the obtained 2D texture I(S(p,q)) and the 2D appearance A is smaller, the 2D shape obtained through face model fitting may become more ideal.

The 3D structure condition may be set to ∥P( S̅( p̅, q̅))−S(p,q)∥², in which S(p,q) denotes the 2D shape, S̅( p̅, q̅) denotes the 3D structure, and P( S̅( p̅, q̅)) denotes projection of the 3D structure S̅( p̅, q̅) onto a 2D plane. As a difference ∥I(S(p,q))−A∥² between the 2D projection P( S̅( p̅, q̅)) and the 2D shape S(p,q) is smaller, the 3D structure obtained through face model fitting may become more ideal.

For more effective revision with respect to the prediction result, embodiments may set additional conditions besides the aforementioned conditions. Therefore, even when an excessive motion or facial expression is generated on the human face, reliability of the prediction result may be increased.

For example, the face fitting unit 30 may fit the 2D model and the 3D model of the human face using at least one condition included in conditions described below.

A 2D deformation condition according to embodiments may be set to ∥p∥² in which p denotes a 2D flexible shape parameter. By setting the 2D deformation condition, a fitting result may be obtained, according to which a degree of 2D deformation is relatively small, and stability of face tracking may be secured. That is, as a deformation degree corresponding to the 2D flexible shape parameter is smaller, the 2D structure obtained through face model fitting becomes more ideal.

A feature point condition according to embodiments may be set to ∥U(S(p)−V)∥² in which S(p) denotes a 2D flexible shape, U(S(p)) denotes a position of a feature point obtained when a feature point matched in the current frame image is deformed to the average shape S₀, and V denotes a position of a deformed feature point matched to a previous frame image. Here, the face fitting unit 30 may receive a feature point predicted by the prediction unit 20, and obtain the position of the feature point U(S(p)) corresponding to the 2D flexible shape S(p) through deformation. In addition, the face fitting unit 30 may include the position V of the deformed feature point matched to the previous frame image. Since a difference ∥U(S(P)−V∥² between feature points matched to neighboring two frame images reflects whether measurement with respect to the feature point is correctly performed, as the difference is smaller, the 2D structure obtained through face model fitting becomes more ideal.

A skin color condition according to embodiments may be set to ∥C(S(p,q))∥², in which S(p,q) denotes the 2D shape, and C(x) denotes similarity between a point in a position x and a skin color in the current frame image. The similarity C(x) may be small when the point in the position x is similar to a skin color within or near a skin area, or may be large otherwise. For example, a function C(x) may be determined using a key frame included in a tracked video image. Here, the key frame may refer to one representative frame image of the video image. A skin area in the key frame may be used by determining the function C(x). A representative key frame included in the video image may be obtained using various methods by an engineer skilled in the art. For example, when the face tracking method according to embodiments is performed, first, a first frame image may be set to the key frame. When a more representative image is measured next, the previous key frame may be updated using the more representative image and used as a new skin color measurement mode. Whether each key point in the 2D shape is located in the skin area may be set as the skin color condition. In this case, stability and reliability of face tracking may be increased. That is, as a difference ∥C(S(p,q))∥² between each key point in the 2D shape S(p,q) and the skin color is smaller, the 2D structure obtained through face model fitting becomes more ideal.

A personality texture condition according to embodiments may be set to ∥I(S(P,q))−W∥², in which W denotes a personality texture of a tracked human face, ∥I(S(p,q))−W∥² denotes the 2D shape, and I(S(p,q)) denotes a 2D texture obtained when the input image I is deformed to a target shape, that is, the average shape S₀. For example, piece-wise warping may be used for the deformation. I(S(p,q)) may be obtained by the method illustrated in FIG. 5. For example, the personality texture W may be set using the key frame included in the tracked video image. Here, the key frame may refer to one representative frame image of the video image. Texture features in the key frame may be used as the personality texture W. A representative key frame included in the video image may be obtained using various methods by an engineer skilled in the art. For example, when the face tracking method according to embodiments is performed, first, a first frame image may be set to the key frame. When a more representative image is measured next, the previous key frame may be updated using the more representative image and used as a new texture mode. As a difference ∥I(S(p,q))−W∥² between the personality texture I(S(p,q)) obtained through deformation and the personality texture W of the tracked human face is smaller, the 2D structure obtained through face model fitting becomes more ideal.

With the foregoing examples, respective conditions have been described. When the foregoing conditions are applied to embodiments, the face fitting unit 30 may fit the predetermined 2D model and 3D model using the at least one condition in combination or all together. In addition, although specific equations have been suggested with respect to the conditions, the equations are not specifically limited. Therefore, any mathematical expressions, which define the 2D deformation, correspondence between the feature points, correspondence between the key point and the skin area, correspondence between personality textures, and the like as the condition, may be all applicable.

For example, when the face fitting unit 30 fits the predetermined 2D model and 3D model based on the 2D position of the key point predicted by the prediction unit 20 using all of the at least one condition in combination, the face fitting unit 30 may set a weight for each of the at least one condition according to practical necessity and characteristics of the tracked video image, thereby obtaining a more practical fitting result.

A plurality of conditions used in combination may form a cost function according to following equations:

$$E ( p , q , \overline{p} , \overline{q} ) = {‖ I ( S ( p , q ) ) - A ‖}^{2} + {k}_{3 D} {‖ P ( \overline{S} ( \overline{p} , \overline{q} ) ) - S ( p , q ) ‖}^{2} + \frac{{k}_{d}}{N} {‖ p ‖}^{2} + \frac{{k}_{f}}{m} {‖ U ( S ( p ) - V ) ‖}^{2} + {k}_{s} {‖ C ( S ( p , q ) ) ‖}^{2} + {k}_{t} {‖ I ( S ( p , q ) ) - W ‖}^{2}$$

Here, N denotes a number of 2D flexible shape parameters, m denotes a number of the matched feature points, k_{3D} denotes a weight of the 3D structure condition, k_{d} denotes a weight of the 2D deformation condition, k_{f} denotes a weight of the feature point condition, kₛ denotes a weight of the skin color condition, and kₜ denotes a weight of the personality texture condition. The face fitting unit 30 may set the key point predicted by the prediction unit 20 as an initial value, thereby obtaining parameters p, q, p̅, and q̅ corresponding to a case in which the cost function has a minimum value and setting the 2D shape and the 3D structure of the tracked human face.

Each condition may be implemented by a corresponding condition mode provided to the face fitting unit 30, respectively, or entirely by the face fitting unit 30. The first frame image may not include a previous input image or prediction result. Therefore, some conditions, such as the feature point condition, the skin color condition, and the personality texture condition, may not be applied in the first frame image. In this case, the conditions may be omitted during fitting of the first frame image and reused from fitting of the second frame image.

According to embodiments, the position of the key point tracked by motion prediction may be obtained preferentially. Therefore, face tracking speed may be increased. In addition, only a single video image input source is necessary while an additional video camera device or sensing device is unnecessary. Accordingly, the face tracking method may be applied to general devices.

In addition, since revision is entirely performed using the at least one condition, stability of the tracking method may be increased. Also, the tracking method may be applied under various natural conditions such as an unacquainted face, non-uniform light, a large change of angle, a strong or asymmetric facial expression.

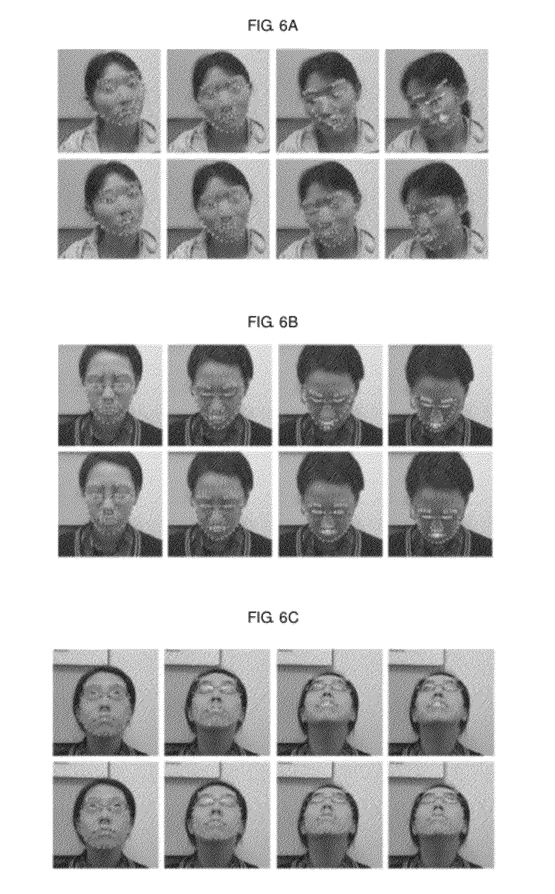

FIGS. 6A to 6C illustrate an improvement in performance of a face tracking scheme according to embodiments in comparison to a related art. In FIG. 6A, upper figures show a case in which motion prediction is not performed and lower figures show a case in which motion prediction is performed, so that the tracking effects are compared. According to FIG. 6A, stability of the tracking is increased when motion prediction is performed. In FIG. 6B, upper figures show a case in which the personality texture condition is used and lower figures show a case in which the personality texture condition is not used, so that the tracking effects are compared. According to FIG. 6B, stability of the tracking is increased when the personality texture condition is used. In FIG. 6C, upper figures show a case in which the 2D deformation condition is used and lower figures show a case in which the 2D deformation condition is not used, so that the tracking effects are compared. According to FIG. 6C, accuracy of the tracking is increased when the 2D deformation condition is used.

The face tracking method and device according to embodiments may be applied to automated monitoring, producing of animation, focus measurement, a smart audio video system, and the like. The system may further include a data input unit, a data analysis unit, a content generation unit, or a content display unit, in addition to the face tracking device.

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

Although embodiments have been shown and described, it would be appreciated by those skilled in the art that changes may be made in these embodiments without departing from the principles and spirit of the disclosure, the scope of which is defined in the claims and their equivalents.

What is claimed is:

1. A device for tracking a human face in a video image, the device comprising:
an image collector to receive the video image and output a current frame image included in the received video image to a predictor;
the predictor to predict a 2-dimensional (2D) position of a key point of the human face in the current frame image output through the image collector based on 2D characteristics and 3-dimensional (3D) characteristics of a human face in a previous frame image obtained through a face fitter, and to output the predicted 2D position of the key point to the face fitter; and
the face fitter to obtain the 2D characteristics and the 3D characteristics by fitting a predetermined 2D model and 3D model of the human face based on the 2D position of the key point predicted by the predictor using at least one condition.

2. The device of claim 1, wherein the 2D characteristics comprise a 2D shape, and the 3D characteristics comprise a 3D structure.

3. The device of claim 1, wherein the face fitter sets the key point predicted by the predictor to an initial value, and fits the predetermined 2D model and 3D model of the human face using the at least one condition.

4. The device of claim 3, wherein the predictor:
extracts a feature point of a face area from the current frame image output from the image collector, and matches the extracted feature point to a feature point of the previous frame image, thereby calculating a 3D shape of the human face in the previous frame image based on a 2D position and a 3D structure of the human face in the previous frame image obtained through the face fitter,
calculates a position of the feature point in the 3D structure, based on the 2D position of the feature point in the extracted previous frame image, a 3D structure of a key point of the human face in the previous frame image obtained through the face fitter, and the 3D shape of the human face in the previous frame image,
calculates a 3D shape of the human face in the current frame image based on the position of the feature point in a 2D position and a 3D structure of the matched feature point of the human face in the current frame image,
calculates the 2D position of the key point of the human face in the current frame image, based on the 3D structure of the key point of the human face in the previous frame image obtained through the face fitter and the calculated 3D shape of the human face in the current frame image, and
outputs the 2D position of the key point to the face fitter.

5. The device of claim 4, wherein the predictor determines the feature point of the face area extracted from a first frame image to be a 2D position of the key point directly predicted.

6. The device of claim 4, wherein the predictor sets a threshold value determining a feature point to a self adaptation threshold value according to an actual state change when the feature point of the face area is extracted from the current frame image output from the image collector.

7. The device of claim 6, wherein the predictor removes an abnormal matching result by using a random sample consensus (RANSAC) method and setting a distance threshold value, when the extracted feature point is matched to the feature point of the previous frame image.

8. The device of claim 5, wherein the face fitter fits the predetermined 2D model and 3D model of the human face based on the 2D position of the key point predicted by the predictor using a plurality of conditions including a 2D appearance condition and a 3D structure condition.

9. The device of claim 5, wherein the face fitter fits the predetermined 2D model and 3D model of the human face according to at least one condition selected from a 2D deformation condition, a feature point condition, a skin color feature point, a personality texture condition.

10. The device of claim 9, wherein the 2D shape is expressed by an equation below:
S(p,q)=T(S(p),q)
wherein S(p) denotes a flexible shape and is expressed by
$$S ( p ) = {S}_{0} + {\sum }_{i} {p}_{i} {S}_{i} ,$$
S₀ denotes an average shape in a 2D model,
Sᵢ denotes a series of shape primitives S₁, S₂, S₃, . . . in the 2D model, each of which denotes a change type of the 2D shape,
p=[p₁, p₂, p₃, . . . ] denotes a 2D flexible shape parameter indicating a change intensity of each shape primitive,
q=[q₁, q₂, q₃, q₄] denotes a 2D stiffness shape parameter, in which q₁ and q₂ denote displacement of a 2D face shape on a plane and q₃ and q₄ denote rotation, contraction, and expansion of the 2D face shape on the plane, and
T denotes a stiffness deformation of the 2D shape based on the displacement, rotation, contraction, and expansion.

11. The device of claim 10, wherein the 3D structure is expressed by an equation below:
S̅( p̅, q̅)= T̅( S̅( p̅), q̅),
wherein S̅( p̅) denotes a 3D flexible shape and is expressed by
$$\overline{S} ( \overline{p} ) = {\overline{S}}_{0} + {\sum }_{i} {\overline{p}}_{i} {\overline{S}}_{i} ,$$
S̅₀ denotes an average structure in a 3D model,
S̅ᵢ denotes a series of structure primitives S̅₁, S̅₂, S̅₃, . . . in the 3D model, each of which denotes a change type of the 3D structure,
p̅=[ p̅₁, p̅₂, p̅₃, . . . ] denotes a 3D flexible structure parameter indicating a change intensity of each structure primitive,
q̅=[θₓ, θ_{y}, θ_{z}, Oₓ, O_{y}, O_{z}] denotes a set of 3D stiffness structure parameters, in which Oₓ, O_{y}, and O_{z} denote angles by which a 3D face structure is rotated along X, Y, and Z axes in a space and θₓ, θ_{y}, and θ_{z} denote displacement of the 3D face structure in the space, and
T denotes a stiffness deformation of the 3D structure based on the rotation and displacement.

12. The device of claim 11, wherein the face fitter sets the 2D deformation condition to ∥p∥²
wherein as a deformation degree ∥p∥² corresponding to the 2D flexible shape parameter p is smaller, a 2D structure obtained through face model fitting becomes more ideal.

13. The device of claim 12, wherein the face fitter sets the feature point condition to ∥U(S(p)−V)∥²,
wherein U(S(p)) denotes a position of a feature point obtained when a feature point matched in the current frame image is deformed to the average shape S₀,
V denotes a position of the feature point matched to the previous frame image, the feature point after deformation, and
as a difference ∥U(S(p)−V)∥² between feature points matched to neighboring two frame images is smaller, the 2D structure obtained through face model fitting becomes more ideal.

14. The device of claim 13, wherein the face fitter sets the skin color condition to ∥C(S(p,q))∥²,
wherein C(x) denotes similarity between a point in a position x and a skin color in the current frame image, and
as a difference ∥C(S(p,q))∥² between each key point in the 2D shape S(p,q) and the skin color is smaller, the 2D structure obtained through face model fitting becomes more ideal.

15. The device of claim 14, wherein
the face fitter sets a function C(x) using a key frame in the video image, and
the key frame denotes one representative frame image of the video image.

16. The device of claim 15, wherein the face fitter initially sets a first frame image to the key frame, and updates the previously used key frame using a more representative frame image when the more representative frame image is measured.

17. The device of claim 14, wherein the face fitter sets the personality texture condition to ∥I(S(p,q))−W∥²,
wherein W denotes a personality texture of a tracked human face,
I(S(p,q)) denotes a 2D personality texture obtained when the current frame image is deformed to the average shape S₀, and
as a difference ∥I(S(p,q))−W∥² between the personality texture I(S(p,q)) obtained through deformation and the personality texture W of the tracked human face is smaller, a 2D shape obtained through face model fitting becomes more ideal.

18. The device of claim 17, wherein the deformation is performed using separate Affine deformation.

19. The device of claim 18, wherein
the face fitter determines the personality texture W using a key frame in the video image, and
the key frame denotes one representative frame image of the video image.

20. The device of claim 19, wherein the face fitter initially sets a first frame image to the key frame, and updates the previously used key frame using a more representative frame image when the more representative frame image is measured.

21. The device of claim 20, wherein the at least one condition forms a cost function according to an equation below:
$$E ( p , q , \overline{p} , \overline{q} ) = {‖ I ( S ( p , q ) ) - A ‖}^{2} + {k}_{3 D} {‖ P ( \overline{S} ( \overline{p} , \overline{q} ) ) - S ( p , q ) ‖}^{2} + \frac{{k}_{d}}{N} {‖ p ‖}^{2} + \frac{{k}_{f}}{m} {‖ U ( S ( p ) - V ) ‖}^{2} + {k}_{s} {‖ C ( S ( p , q ) ) ‖}^{2} + {k}_{t} {‖ I ( S ( p , q ) ) - W ‖}^{2}$$
wherein N denotes a number of the 2D flexible shape parameters,
m denotes a number of the matched feature points,
k_{3D} denotes a weight of the 3D structure condition,
k_{d} denotes a weight of the 2D deformation condition,
k_{f} denotes a weight of the feature point condition,
kₛ denotes a weight of the skin color condition,
kₜ denotes a weight of the personality texture condition, and
wherein the face fitter sets the key point predicted by the prediction unit as an initial value, thereby obtaining parameters p, q, p̅, and q̅ corresponding to a case in which the cost function has a minimum value and setting the 2D shape and the 3D structure of the tracked human face.

22. The device of claim 21, wherein the face fitter sets a weight of each of the at least one condition according to practical necessity and characteristics of the tracked video image.

23. A method for tracking a human face in a video image, the method comprising:
receiving the video image and outputting a current frame image which is the received video image, by an image collector;
predicting a 2-dimensional (2D) position of a key point of a human face in the current frame image output through the image collector based on 2D characteristics and 3-dimensional (3D) characteristics of a human face in a previous image obtained by a face fitter and outputting the predicted 2D position of the key point to the face fitter, by the predictor; and
obtaining the 2D characteristics and the 3D characteristics of the human face by fitting a predetermined 2D model and 3D model of the human face by the face fitter based on the 2D position of the key point predicted by the predictor using at least one condition.

24. The method of claim 23, wherein the 2D characteristics comprise a 2D shape, and the 3D characteristics comprise a 3D structure.

25. The method of claim 24, wherein the predicting of the 2D position of the key point of the human face in the current frame image output by the image collector by the predictor comprises:
extracting a feature point of a face area from the current frame image output from the image collector, and matching the extracted feature point to a feature point of a previous frame image, thereby calculating a 3D shape of a human face in the previous frame image based on a 2D position and a 3D structure of the human face in the previous frame image obtained through the face fitter,
calculating a position of the feature point in the 3D structure, based on a 2D position of a feature point in the extracted previous frame image, a 3D structure of a key point of the human face in the previous frame image obtained through the face fitter, and the 3D shape of the human face in the previous frame image,
calculating a 3D shape of the human face in the current frame image based on the position of the feature point in a 2D position and a 3D structure of the matched feature point of the human face in the current frame image, and
calculating the 2D position of the key point of the human face in the current frame image, based on the 3D structure of the key point of the human face in the previous frame image obtained through the face fitter and the calculated 3D shape of the human face in the current frame image.

26. The method of claim 25, wherein the face fitter fits a predetermined 2D model and 3D model of the human face based on the 2D position of the key point predicted by the predictor using a plurality of conditions including a 2D appearance condition and a 3D structure condition.

27. The method of claim 26, wherein the face fitter fits the predetermined 2D model and 3D model of the human face according to at least one condition selected from a 2D deformation condition, a feature point condition, a skin color feature point, a personality texture condition.

28. At least one non-transitory computer readable medium storing computer readable instructions that control at least one processor to implement the method of claim 23.
